(19) United States
(12) Patent Application Publication
(10) Pub. No.: US 2004/0172788 A1
(43) Pub. Date: Sep. 9, 2004

(54) Positional guiding aid

(76) Inventor: Glen Heavenor, Glasgow (GB)

Correspondence Address: Fleshner & Kim, Suite 1100, 2325 Dulles Corner Boulevard, Herndon, VA, 20171, US

(21) Appl. No.: 10/483,386

(22) PCT Filed: Jul. 11, 2002
(86) PCT No.: PCT/GB02/03188

(30) Foreign Application Priority Data
Jul. 13, 2001 (GB) 0117073.7

(51) Int. Cl. B62B 1/00

(52) U.S. Cl. 16/430

(57) ABSTRACT

A positional guiding aid for incorporation an the handle of a hand-controlled apparatus. The aid comprises a protuberance over which a user repositions their grip during use of the hand-controlled apparatus so as to provide the user with increased comfort and dexterity of use of the apparatus. A variety of example embodiments are provided such as a toothbrush, rotary cutter, radial hairbrush, pushchair and writing instrument.

The present invention relates to hand held aids to assist in the operation of hand controlled apparatus. More particularly the invention relates to a positional guiding aid for incorporation on a handle to provide the user with increased comfort and dexterity of use of the apparatus to which the handle is attached.

When presented with an apparatus which has a handle, and in particular when the handle has a shaft, a user will tend to provide a hammer like grip to the shaft. This grip can generally be described as wrapping the fingers around the shaft of the handle while resting the thumb over the fingers or preferably placing the pad of the thumb on a longitudinal axis of the shaft. Such a grip tightly holds the apparatus while operation of the apparatus is achieved by movements of the wrist and by a limited down force provided by the thumb against the longitudinal axis. When the thumb presses down on the longitudinal axis a lever is set up between the pad of the thumb and the third and fourth digits of the same hand. Due to the longitudinal alignment of the thumb and the third and fourth digits in this position only a limited amount of leverage and hence torque can be applied through the handle without the use of the wrist.

The study of ergonomics has taught us that if we can reduce the amount of wrist movement in operating apparatus we can reduce the amount of cramp experienced by a user and make handling the apparatus more comfortable. Ergonomic handles have tended to change the shape of the handle to suit the users palm and finger morphology contacting the handle. Additionally thumb rest positions have been provided on handles to increase the area to which the thumb may apply a torque to operate the apparatus. Thus the handle is made to fit the form of the hand, sometimes referred to as “form fitting”. By form fitting a user will grip the handle at a single position, “locking” their hand in position and the form fitting prevents them from manipulating the handle within their hand during use. Though these handles provide a more comfortable grip they do not assist in manipulation of the apparatus as the wrist must still do the work and further they are limited in that they must be made to fit a users hand size and match a left or right handed grip. Much work has been done in providing an ergonomic handle for a toothbrush where a head of bristles must be controllably manipulated against the teeth of a user. Most toothbrushes now have a planar surface on the longitudinal axis of the handle, which includes a widened portion for a thumb rest at the top of the handle towards the bristles. When a user grips the handle, their third and fourth digits rest on the planar surface, while the thumb is positioned on the thumb rest. Manipulation of the bristles is achieved by shifting the thumb to one side of the longitudinal axis and applying pressure by the thumb or the third and fourth digits to cause the handle and thus the bristles to rotate. This occurs as a lever is set up between the position of the thumb on the rest and the third and fourth digits on the planar surface. The balance point of the lever is a position on the palm of the hand, typically the third joint of the second finger. These toothbrushes require the user to have above average dexterity as the handle must be balanced to achieve controlled rotation of the handle while pressure must be applied evenly. In fact most users will tend to adopt the position of having the thumb on the longitudinal axis and manipulate the brush with the wrist. While this is adequate for short term use, as you would expect for a toothbrush, it limits the length of time other utensils can be comfortably operated. Additionally it is generally only appropriate to utensils with a working surface i.e. the bristles, being coplanar to the planar surface on which the thumb and digits rest. For apparatus such as toothbrushes and razors where the apparatus requires to be used at a preferred angle or tilt, a hand-held utensil is described in International Patent Application No WO 97/44164. This utensil includes a handle having a moulded thumb rest which spirals from a first position substantially central to the longitudinal axis of the handle to a second position substantially outside the longitudinal axis of the handle, the spiral being formed in the direction of off-set of the head or tool portion as it approaches the head of the utensil. While this handle encourages a user of the utensil to present the head or tool to an article at a preferred angle or tilt, it has a number of disadvantages, namely, as the thumb rest spirals from the longitudinal axis the thumb is positioned close to the axis giving limited rotation to the handle in use, additionally the head must be mounted in an off-set position to the handle and thus the utensil has a handedness such that right and left handed versions must be made.

It is an object of at least one embodiment of the present invention to provide a positional guiding aid which in combination with a handle provides a lever action to a user for increased comfort of use of the apparatus to which the handle is connected.

It is a further object of at least one embodiment of the present invention to provide a positional guiding aid which allows a user to advantageously continuously reposition there grip of a handle to which the aid is attached.

It is yet a further object of at least one embodiment of the present invention to provide a positional guiding aid which in combination with a handle provides both right and left handed persons with an increased dexterity of movement of an apparatus attached to the handlde.

According to a first aspect of the present invention there is provided a positional guiding aid for incorporation on a handle of an apparatus, the aid comprising a substantially rounded protuberance offset from a longitudinal axis of the aid, the longitudinal axis of the aid being arranged to lie on a longitudinal axis of the handle the protuberance including an upper surface and a lower surface being parts of a single continuous surface over the protuberance, the upper surface including a first axis located thereon at a displacement angle from the longitudinal axis and characterised in that the first, axis is perpendicular to a second axis also located on the upper surface, and the upper surface is arranged on a portion of a double helix defined by rotation of the second axis around the first axis.

As the aid is a protuberance as opposed to a thumb rest, a user may apply any finger or thumb to any location on the surface of the protuberance to effect a first point on a lever. The opposing point on the lever will be defined by the point of intersection between the first axis and the longitudinal axis where the displacement angle is formed. Thus a user may adopt any grip position on the handle which is most comfortable to them.

The substantially rounded continuous surface of the aid allows a user to continuously adjust the first point on the lever and so provide increased manipulation of the apparatus without wrist movement. Thus the aid allows a user to advantageously continuously reposition their grip of a handle to which the aid is attached.

Additionally as the user can place any finger or thumb at any location on the surface of the protuberance there is no handedness to the protuberance and thus apparatus including the aid may equally be used by a right handed or left handed individual.

Displacement of the protuberance from the longitudinal axis of a handle to which it is attached provides increased leverage for the user and hence increased manipulation of the apparatus to which the handle is attached.

Preferably a width of the protuberance defined by a length of the second axis on the upper surface is greater than a thickness of the protuberance defined as a distance between the upper and lower surfaces. This encourages a user to select a first point on the lever at a distance from the longitudinal axis and thereby obtain increased leverage of the apparatus. Additionally, the user will naturally centre their digit, thumb or finger on the protuberance.

Preferably the lower surface is arranged parallel to the upper surface. So, like the upper surface, the lower surface will also lie on a double helix which provides a comfortable and stable surface on which a users fingers or thumb may rest.

Preferably the displacement angle is an acute angle. Advantageously the displacement angle is in the range 5 to 45 degrees. Selection of the displacement angle may be by an inverse relationship to the distance between the point of intersection of the first axis and the longitudinal axis, and the point of intersection of the first and second axis.

According to a second aspect of the present invention there is provided a handle for use on hand controlled apparatus, the handle including a positional guiding aid according to the first aspect of the present invention.

Preferably the handle comprises a shaft on the longitudinal axis. Preferably the shaft includes a substantially planar surface parallel to the longitudinal axis. More preferably the planar surface is arranged such that the point of intersection between the first axis and the longitudinal axis where the displacement angle is formed lies thereon.

Thus, in use, the opposing point on the lever is on the planar surface which will increase the dexterity of manipulation of the handle and consequently the hand held utensil by a user. This is achieved as that part of a users hand, typically the third and fourth digits, located at the opposing point will remain stationary as that part of the users hand, typically the thumb located at the first point of the lever will be continuously repositioned over the surface of the protuberance between extreme positions between which the handle and thus the article will rotate.

The shaft may include a plurality of substantially planar surfaces parallel to the longitudinal axis. Advantageously, the shaft includes three substantially planar surfaces parallel to the longitudinal axis. Such a triangular cross-sectional handle provides better leverage as the user requires less grip to manipulate the handle.

According to a third aspect of the present invention there is provided a hand controlled apparatus, the apparatus comprising a moveable portion and at least one handle to effect movement of the moveable portion, wherein the at least one handle is according to the second aspect.

Thus the apparatus of the present invention may be any hand controlled apparatus currently in use but which incorporates the positional guiding aid of the first aspect onto the at least one handle.

Preferably the apparatus has one handle. Embodiments of such apparatus include vacuum cleaners and walking sticks together with all hand-held utensils such as brushes, cooking utensils, sports racquets and writing instruments. Alternatively the apparatus may include two handles. Embodiments of such apparatus include wheelchairs, lawnmowers, prams and pushchairs.

Preferably the moveable portion includes at least one longitudinal axis located adjacent an attachment point to the at least one handle. Preferably the at least one longitudinal axis of the moveable portion is co-linear with the longitudinal axis of the at least one handle. An embodiment of such an apparatus would be a conductors baton.

Alternatively the at least one longitudinal axis of the moveable portion may be offset with respect to the longitudinal axis of the handle. An embodiment of such an apparatus would be an angled toothbrush.

Preferably the moveable portion includes a working section, the working section being defined as that part of the moveable portion which requires to be manipulated by the user. The working section may be a surface of the moveable portion. Embodiments of such apparatus may be hairbrushes, toothbrushes, paint brushes, and writing instruments. Where the working section is on a plane parallel to the longitudinal axis of the moveable portion it may be advantageous to attach the moveable portion to the handle such that the plane of the working section is rotated on the longitudinal axes so that the plane of the working section is non co-planar with the substantially planar surface of the shaft of the handle. More preferably the plane of the working section is on a plane parallel to the plane created by the first and second axis. An embodiment of such an apparatus would be a knife where the cutting edge is the working section. An alternative example of such an apparatus may be a toothbrush.

Preferred embodiments of apparatus are radial hairbrushes, pens, pencils, ski poles and the like. Such apparatus is characterised in that it has a working section which is operational over the majority of 360 degrees rotation of the handle. The additional leverage and rotational control afforded by the positional guiding aid provides increased use of the working section on such apparatus.

Example embodiments of the present invention will now be described, by way of example only, with reference to the accompanying figures in which:

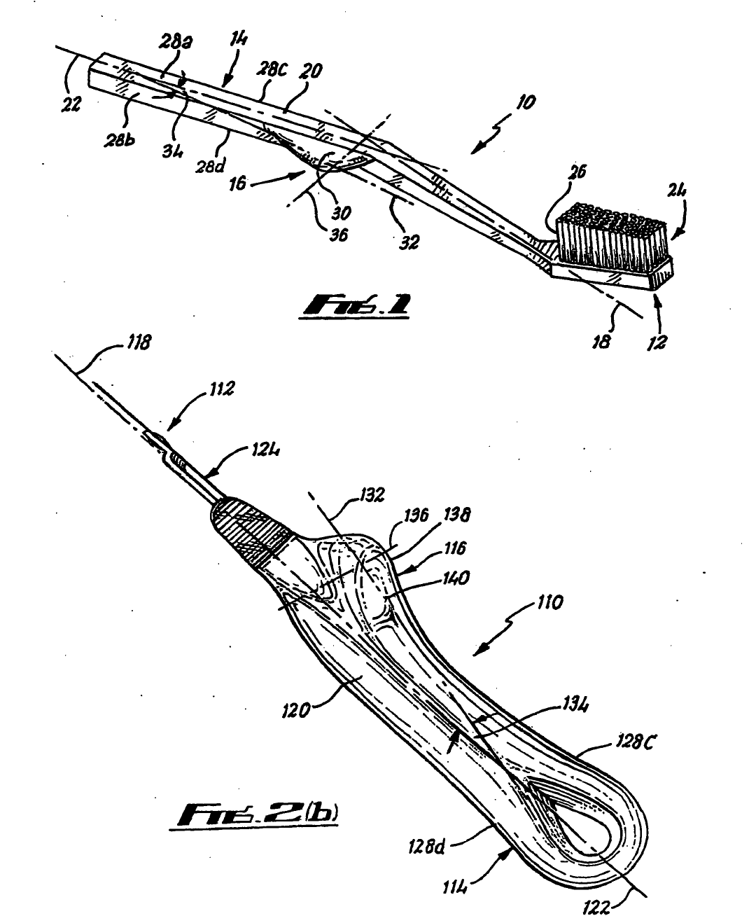

FIG. 1 is a schematic illustration of a positional guiding aid incorporated on a handle of an apparatus in accordance with a first embodiment of the present invention;

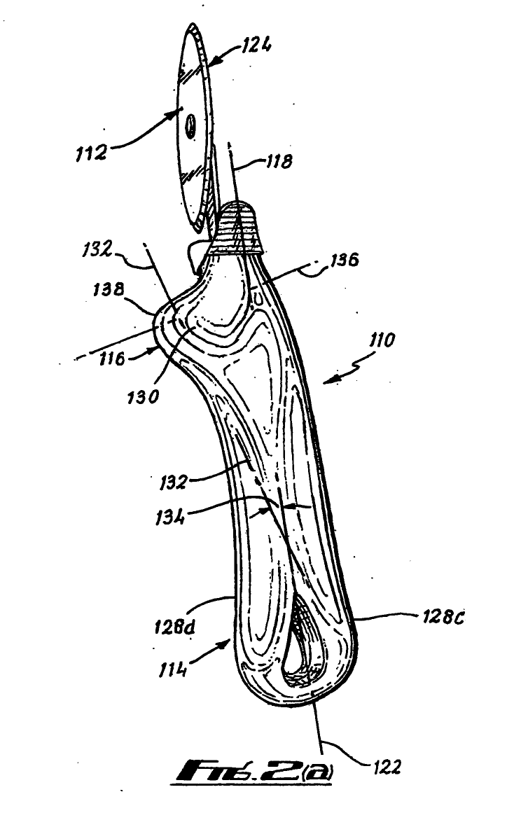

FIG. 2(a) and (b) are top and bottom views respectively of a positional guiding aid incorporated on a handle of an apparatus in accordance with a second embodiment of the present invention;

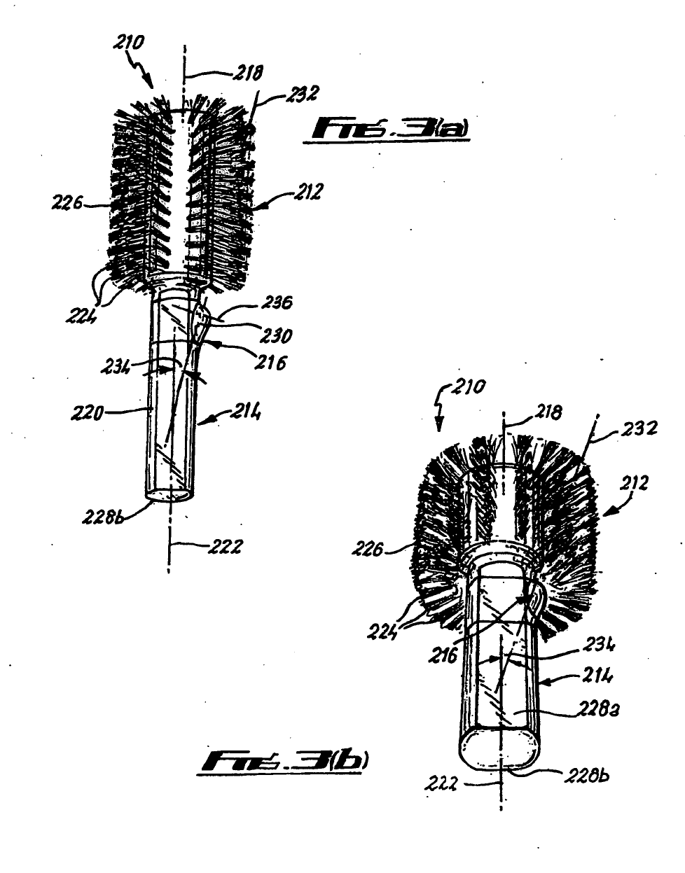

FIGS. 3(a) and 3(b) are a side view and a perspective view, respectively, of a positional guiding aid incorporated on a handle of an apparatus in accordance with a preferred embodiment of the present invention;

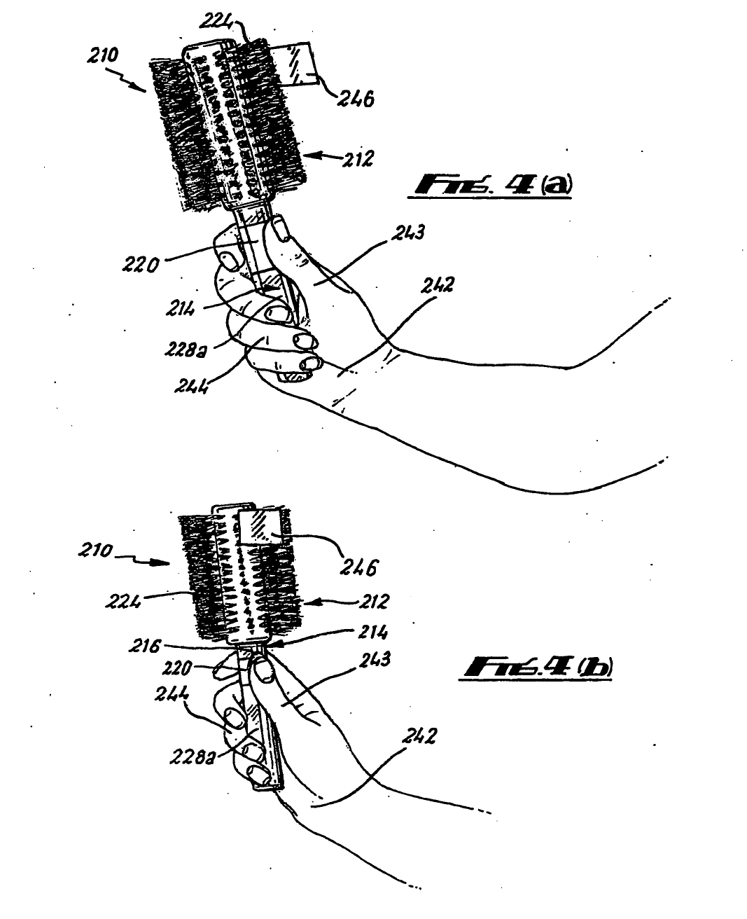

FIGS. 4(a) to (e) are a series of views of the apparatus of FIG. 3 in use; and

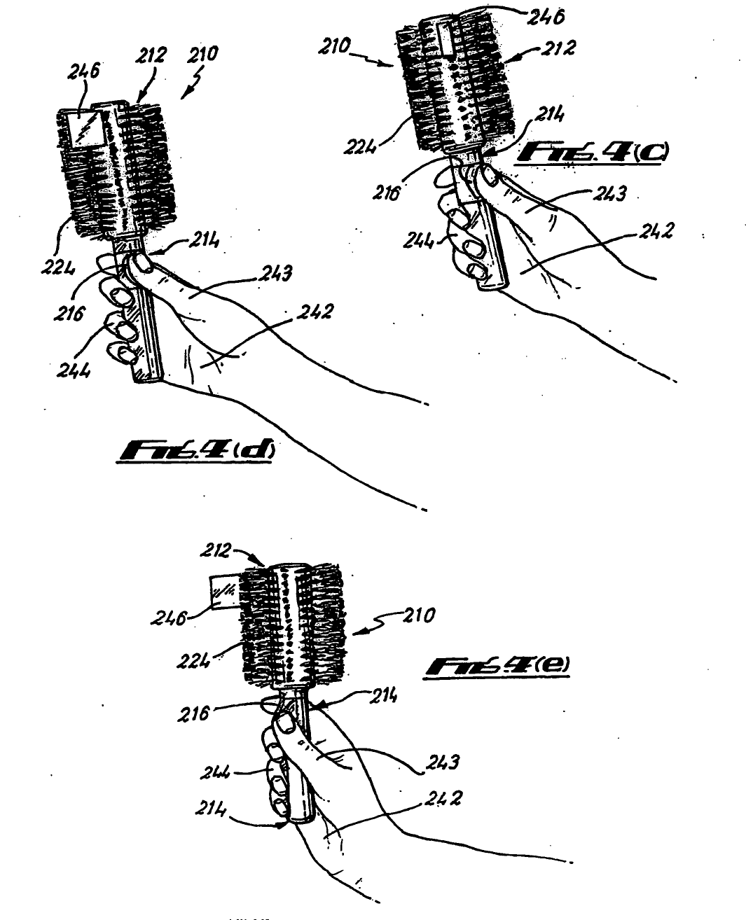

FIG. 5 is a perspective view of positional guiding aids incorporated on handles of an apparatus in accordance with a fourth embodiment of the present invention;

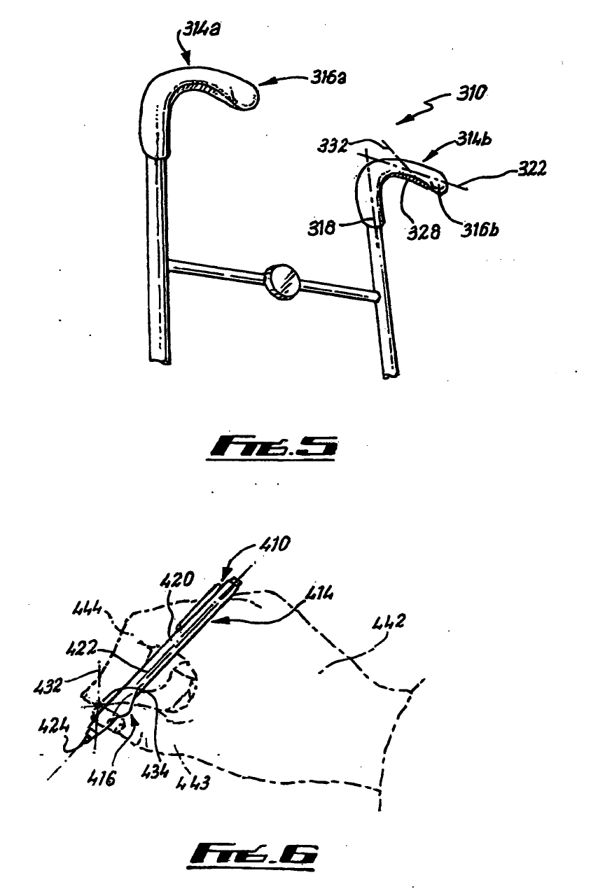

FIG. 6 is a perspective view of apparatus including a positional guiding aid, in use, in accordance with a fifth embodiment of the present invention, in use.

Reference is initially made to FIG. 1 of the drawings which illustrates an apparatus in accordance with a first embodiment of the present invention. The apparatus of FIG. 1 is a toothbrush, generally indicated by reference numeral 10. Toothbrush 10 comprises a head 12 which is a moveable portion and a handle 14 attached thereto. Located on the handle 14 is a positional guiding aid 16 as will be described hereinafter. Toothbrush 10 is a standard angled head toothbrush except for the aid 16. Thus the longitudinal axis 18 of the head 12 is offset from the longitudinal axis 22 of the shaft 20 of the handle 14. The head 12 has a working section 24 formed by the surface of the bristles 26.

Handle 14 comprises a shaft 20 connected to the moveable portion 12. Shaft 20 has four planar surfaces 28a-d arranged around the longitudinal axis 22. Extending from the upper surface 28a of the shaft 20 is a positional guiding aid 16. Aid 16 appears as a protuberance or swelling from the handle 14. The aid 16 has an upper surface 30 and a lower surface (not shown) which are parts of a single continuous surface of the aid 16. The aid 16 is therefore made of a material capable of taking on a smoothed or polished surface such as a plastic or polished wood. The aid 16 is offset from the longitudinal axis 22 of the shaft 20. The off-set is provided by virtue of positioning the aid on a first axis 32 which is on the same plane as the surface 28a and displaced from the longitudinal axis 22 by a displacement angle 34. In this embodiment the displacement angle is around 15 degrees. On the upper surface 30 is a second axis 36 which is perpendicular to the first axis 32. The second axis 36 extends across the upper surface 30. A characteristic of the protuberance is that it is arranged such that the second axis 36, and thus the surface 30 describes part of a double helix formed by the second axis 36 rotating with respect to the first axis 32. Thus viewed from above the upper surface 30 of the aid 16 effectively forms a right handed screw. The resultant edge effect between the upper 30 and lower surfaces improves stability and grip of a digit or thumb as it travels over the protuberance. It should also be noted that in this embodiment the working section 24 is planar with the surface 28a.

In use, an individual will preferably fold their hand around the handle 14. It is immaterial whether they use their right or left hand. In the same way it will be appreciated that the aid 16 could equally positioned on the opposite side of the handle 14. The individual may naturally place their thumb upon the upper surface 30 while their third and fourth digits rest at the point the displacement angle 34 originates. Part of the handle 14 may also rest on the individual's palm. To manipulate the bristles 26 against the teeth the user operates their third and fourth digits in opposition to their thumb to produce a lever which allows torque to be applied to the handle 14 or aid 16. Applying torque to the aid 16 will cause the toothbrush 10 to rotate in the individuals hand. To ease comfort on the hand the user will tend to move their thumb over the surface of the aid 16, relocating it in a continuous action from the upper surface 30 to the lower surface as the toothbrush 10 is rotated. This entire action is achieved without the need for the individual to rotate the wrist by any significant amount. Good control can be achieved when the thumb is on the lower surface as the surface provides an apparent lip due to the fact that the width of the protuberance at the second axis 36 is greater than the thickness of the protuberance between the upper 30 and lower surfaces. The entire motion and control of the toothbrush 10 is achieved through relatively small loose movements of the fingers and thumb as the handle 14 is gently balanced in the hand. Thus there is no strain experienced by any part of the individuals hand or wrist.

The toothbrush 10 also operates well if the individual chooses to place a digit, for instance the first digit or index finger, against the aid 16. In this configuration, the third and fourth digits will rest at the origin of the displacement angle 34 on the opposing surface 28c to the top surface 28a of the handle 14. The thumb will provide the balance point of a lever created between the third/fourth digits and the first digit. The lever provides rotation to the toothbrush 10 as before with the first digit now continuously travelling over the surface of the aid 16. This action is effected without strain to the wrist.

Reference is now made to FIG. 2(a) and (b) of the drawings which illustrate an apparatus in accordance with a second embodiment of the present invention. The apparatus of FIG. 2 is a rotary pizza cutter, generally indicated by reference numeral 110. Like parts to those of FIG. 1 have been given the same reference numeral with the addition of 100. This embodiment operates in an identical fashion to the embodiment of FIG. 1.

The embodiment of FIG. 2 illustrates a hand held utensil where the longitudinal axis 118 of the moveable portion 112 is co-linear with the longitudinal axis 122 of the handle 114. Additionally the working section 124, which in this case is the edge of the blade around the rotary cutter, is offset from the planar surface 128a by rotation of the head 112 with respect to the handle 114. This offset is required as the cutter must be presented to an article, i.e. a pizza base, with the blade perpendicular to the article. Unlike the articles with off-set heads of the prior art, International Patent Application No. WO 97/44164, this apparatus 110 can equally be used with the right or left hand and can also be used with a finger placed on the aid 116 as opposed to a thumb as required in the prior art. In fact, for this embodiment where the apparatus does not require to be rotated during use, leverage can most comfortably be effected by resting the index finger on the upper surface 130 of the aid 116 as opposed to the thumb. Use of the thumb is best achieved when the thumb is rested to the edge 138 of the aid 116 between the upper 130 and lower 140 surfaces.

Turning now to FIGS. 3(a) and (b) of the drawings which illustrate an apparatus in accordance with a preferred 3 embodiment of the present invention. The apparatus of FIG. 3 is a radial hairbrush, generally indicated by reference numeral 210. Like parts to those of FIG. 1 have been given the same reference numeral with the addition of 200.

Hairbrush 210 comprises a head 212 of bristles 224 arranged radially and longitudinally to the axis 218, and a handle 214 including a positional guiding aid 216. The handle 214 is substantially circular in cross-section having opposing planar faces 228a,b from a longitudinal axis 222. The head 212 and handle 214 are co-linear. The bristles 224 on the head 212 provide a cylindrical working section 226 having 360 coverage around the hairbrush 210. The positional guiding aid 216 has been mounted on the handle 214 and thus unlike the second embodiment the handle 214 has not been moulded to fit with the protuberance of the aid 216. This illustrates that an aid 216 may be incorporated onto practically any handle. The aid 216, as described hereinbefore, is a protuberance or swelling from the handle 214. The protuberance is located at a displacement angle 234 with respect to an axis 222 of the handle. The displacement angle 234 is located at a position which reflects the location at which the third and fourth digits will rest on the handle 234. The profile of the aid is that of a double helix formed from a perpendicular axis through the aid rotating with respect to the axis 232 formed from the projection at the displacement angle 234.

FIGS. 4(a) to (e) illustrate the radial hairbrush 210 in use. Referring initially to FIG. 4(a), the user has adopted a classic grip around the handle 214 of the brush 210 to grasp the shaft 220. The users hand 242 is wrapped around the shaft 220 with the thumb 243 resting against the upper surface of the positional guiding aid (not seen in this Figure). The users second, third 244 and fourth digits are held against the shaft 220 with the third digit 244, the ring finger, having its pad against the planar surface 228a of the shaft 220. The location of the third digit 244 on the planar surface 228a defines the position where the displacement angle 234 (not shown) originates for the location of the positioning aid 216. As individual's hand sizes vary the location of the third digit 244 on the origin of the displacement angle 234 is not crucial and most individuals will find a comfortable position for themselves around this origin. This may of course lead some individuals to rest a different digit at this position, but typically a digit or a thumb will naturally sit comfortably at this location. With the hand 242 shown in the position of FIG. 4(a) a lever is set up between the third digit 234 on the planar surface 228a and the thumb 243 on the upper surface of the positional guiding aid. The balance position of this lever is in the palm of the users hand 242, most likely at the third joint of the second digit. By actuating the lever the user can pitch the angle of the brush in relation to the object being brushed e.g. a head of hair. This assists the user in presenting the brush 210 at the correct angle to the hair, say, without adjustment of the wrist. Thus while maintaining a light comfortable grip on the shaft 220 the user, by simply throwing the balance of the lever with the thumb 243 and finger tip 244, can adjust the tilt or pitch of the brush 212.

The head of the brush 212 comprises longitudinal equally spaced rows of bristles. There are fourteen rows of bristles in the brush 210. To aid the viewers appreciation of the position of the bristles during operation of the brush 210 a marker 246 has been attached to the top of a single row of bristles. The marker 246 is a radially mounted slip of paper. In FIG. 4(a) the marker 246 is seen to be located on a right hand side of the brush 210.

Referring now to FIG. 4(b) it can be seen that the user has applied some torque to the lever at the position of the third digit 244. This has caused the user to reposition her grip by moving her thumb 243 across the upper surface of the aid 216 towards the outer edge of the aid 216. No effective movement of the users wrist has been made, but the marker 246 illustrates that the working section 224 of the brush has rotated through approximately 60 degrees.

Further application of torque through minimal pressure of the third digit 224 on the planar surface 228a causes the brush 210 to rotate further. This is shown in FIG. 4(c). The thumb is now located over the edge of the aid towards the lower surface of the aid. Repositioning of the thumb has been achieved as a continuous action by sliding the thumb over the continuous surface of the aid 216 in a controlled and natural manner. Again note that the wrist has not been used to effect this movement and is perfectly relaxed in posture.

FIG. 4(d) shows the rotation achieved by the marker 246 when a little further controlled light pressure is applied by the third digit 244 against the planar surface 228a. The thumb 243 is now located on the lower surface of the aid 216. At this stage light pressure can be applied by the thumb 243 to assist in the rotation. Again note that the wrist has not been used to effect this movement and is perfectly relaxed in posture.

The furthest extension of the thumb 243 without use of the wrist is demonstrated in FIG. 4(e). This illustrates the maximum rotation achieved by the working section 224 via the marker 246. In comparison to FIG. 4(a) it can be seen that the marker has been rotated through at least 180 degrees. Thus by placing a positional guiding aid onto a radial hairbrush an extraordinary increase in effective working area (section 244) can be used so increasing the sweep available to the user as they brush their hair. In contrast prior art radial brushes gripped and used by rotation of the wrist typically provide a rotation limited to 45 degrees.

This advantage of increased rotation and dexterity in manipulation of the brush 210 can be seen with any hand held article where a 360 degree working section is provided on the article and the head of the article is co-linear with the handle on which the aid is mounted or incorporated. Examples of such articles include pens, pencils, balloon whisks, awls, walking sticks and ski poles. However it will be appreciated that a large range of articles exist to which the positional guiding aid could be incorporated to assist a user in the manner described with reference to FIGS. 4(a) to (e). As with the other embodiments described hereinbefore, the radial brush can be as effectively operated with the left or right hand and by a grip which uses a different arrangement of digits and/or thumb to provide the lever.

The invention is not limited to apparatus having a single handle and this is illustrated in FIG. 5. Dual handles 314a,b are shown in FIG. 5 attached to an article (not shown) 310 in accordance with a fourth embodiment of the present invention. Like parts to those of FIG. 1 have been given the same reference numeral with the addition of 300. Parts relating to each handle are suffixed ‘a’ and ‘b’ as appropriate.

The handles 314a,b are arranged to be attached to a child's pushchair and thus point away from the body of the user. The positional guiding aids 316a,b are located at the distal ends of the handles 314a,b and are shown as inwardly facing. The aids could equally be mounted on the outside edges of the handles 314a,b. In this embodiment the longitudinal axis of the article 318 is substantially vertical and at an acute angle to the longitudinal axis 322 of the handle. The positioning of the aid 316 on the handle is still on a displaced angle and has a surface on a double helix as described hereinbefore with reference to the earlier embodiments. The planar surface 328 against which the third and fourth digits rest to provide one end of the lever is now located to one side of the handle to provide a more comfortable position for the hands during use.

This is particularly important as apparatus incorporating dual handles is commonly used for long periods of time. The positional guiding aids 316a,b on this article allow a user to control the pushchair through small grip changes in relation to the thumb positioned over the surface of the aids 316a,b. Steering of the pushchair becomes easier as does tilting the pushchair to raise the back or front wheels to overcome obstacles such as curbs.

The arrangement of handles shown in FIG. 5 could be used on other articles such as wheelchairs, prams, lawnmowers and shopping trolleys.

Finally reference is made to FIG. 6 of the drawings which illustrates a writing instrument including a positional guiding aid according to a fifth embodiment of the present invention. The writing instrument is a pen, generally indicated by reference numeral 410. Like parts to those of FIG. 1 have been given the same reference numeral with the addition of 400. A users hand 442 has been outlined on the Figure to illustrate the grip adopted when using the pen 410.

Pen 410 has a shaft 420 leading to a point 424, the working section, which contacts the paper or other material to be written on. The shaft 420 and point 424 are co-linear on the longitudinal axis 422 of the handle 414. As with the radial hairbrush, the working section 424 of the pen 410 is 360 degrees around the longitudinal axis 422 and additionally the point can be used on this axis 422 also. The shape of the handle 414 is immaterial although as described hereinbefore a triangular cross-section may assist in griping the pen. As described hereinbefore, a positional guiding aid 416 is mounted on the shaft towards the working section 424. In this embodiment the origin of the displacement angle 434 is close to the working section 424 and as a result the displacement angle will be approximately 45 degrees. This provides an aid 416 with a distinct swelling and strongly pitched surface for the double helix arrangement. The lever is now established via the first digit 444 resting at a point close to or on the origin of the displacement angle 434 and the thumb positioned on the surface of the aid 416. Balance is achieved via the second digit resting under the pen in the view shown. Additionally the handle 414 rests on the side of the palm. Balance is best achieved if a planar surface is located at the second digit and for a triangular handle this would also preferentially provide a planar surface resting against the palm.

Pressure applied by the first digit 444 provides the contact of the point 424 with the surface of the paper being written on while movement of the thumb 443 over the surface of the aid 416 provides additional control in writing over that which would be experienced using a standard grip on a pen without an aid 416 attached.

A further feature of the positional guiding aid 416 for use on a pen 410 is that it may be moulded into a rubber sleeve which can then be located on a standard pen or pencil. Currently pens are manufactured with rubber sleeves to assist in gripping the pen during use, but these offer no rotational control in use as opposed to the positional guiding aid.

The principal advantage of the present invention is that it provides a positional guiding aid which allows a user to continuously adjust their grip and so provide increased manipulation of apparatus to which the aid is 29 incorporated without wrist movement.

Additionally as the user can place any finger or thumb at any location on the surface of the protuberance of the aid there is no handedness to the protuberance and thus apparatus including the aid may equally be used by a right handed or left handed individual. For this reason also the aid may be mounted on either side of a handle making it more adaptable for incorporation on a handle.

A further advantage of the present invention is that by displacement of the protuberance of the aid from the longitudinal axis of a handle to which it is attached, the aid provides increased leverage for the user and hence increased manipulation in the form of pitch and rotation of the apparatus to which the handle is attached. This advantage is particularly seen for apparatus having a radial working section and where the moving portion is co-linear with the shaft of the handle e.g. radial hairbrush.

It will be appreciated by those skilled in the art that various modifications may be made to the present invention without departing from the scope there of. In particular a wider variety of apparatus may be adapted to incorporate the positional guiding aid. For example a part radial hairbrush could be made wherein the bristles extend over an area equal to the rotation experienced using the positional guiding aid.

1. A positional guiding aid for incorporation on a handle of an apparatus, the aid comprising a substantially rounded protuberance offset from a longitudinal axis of the aid, the longitudinal axis of the aid being arranged to lie on a longitudinal axis of the handle, the protuberance including at upper surface and a lower surface being parts of a single continuous surface over the protuberance, the upper surface including a first axis located thereon at a displacement angle from the longitudinal axis, and characterised in that the first axis is perpendicular to a second axis also located on the upper surface, and the upper surface is arranged on a portion of a double helix defined by rotation of the second axis around the first axis.

2. A positional guiding aid as claimed in claim 1 wherein a width of the protuberance defined by a length of the second axis on the upper surface is greater than a thickness of the protuberance defined as a distance between the upper and lower surfaces.

3. A positional guiding aid as claimed in claim 1 or claim 2 wherein the lower surface is arranged parallel to the upper surface.

4. A positional guiding aid as claimed in any preceding claim wherein the displacement angle is an acute angle.

5. A positional guiding aid as claimed in claim 4 wherein the displacement angle is in the range 5 to 45 degrees.

6. A positional guiding aid as claimed in claim 4 wherein the displacement angle is derived by an inverse relationship to the distance between the point of intersection of the first axis and the longitudinal axis, and the point of intersection of the first and second axis.

7. A handle for use on hand controlled apparatus, the handle including a positional guiding aid according to any one of claims 1 to 6.

8. A handle as claimed in claim 7 wherein the handle comprises a shaft on the longitudinal axis.

9. A handle as claimed in claim 8 wherein the shaft includes a substantially planar surface parallel to the longitudinal axis.

10. A handle as claimed in claim 9 wherein the planar surface is arranged such that the point of intersection between the first axis and the longitudinal axis where the displacement angle is formed lies thereon.

11. A handle as claimed in any one of claims 8 to 10 wherein the shaft includes a plurality of substantially planar surfaces parallel to the longitudinal axis.

12. A handle as claimed in claim 11 wherein the shaft includes three substantially planar surfaces parallel to the longitudinal axis.

13. A hand controlled apparatus, the apparatus comprising a moveable portion and at least one handle to effect movement of the moveable portion, wherein the at least one handle is according to any one of claims 7 to 12.

14. A hand controlled apparatus as claimed in claim 13 wherein the apparatus has one handle.

15. A hand controlled apparatus as claimed in claim 13 wherein the apparatus includes two handles.

16. A hand controlled apparatus as claimed in any one of claims 13 to 15 wherein the moveable portion includes at least one longitudinal axis located adjacent an attachment point to the at least one handle.

17. A hand controlled apparatus as claimed in claim 16 wherein the at least one longitudinal axis of the moveable portion is co-linear with the longitudinal axis of the at least one handle.

18. A hand controlled apparatus as claimed in claim 16 wherein the at least one longitudinal axis of the moveable portion is offset with respect to the longitudinal axis of the handle.

19. A hand controlled apparatus as claimed in any one of claims 13 to 18 wherein the moveable portion includes a working section, the working section being defined as that part of the moveable portion which requires to be manipulated by the user.

20. A hand controlled apparatus as claimed in claim 19 wherein the working section is a surface of the moveable portion.

21. A hand controlled apparatus as claimed in claim 20 wherein the working section is on a plane parallel to the longitudinal axis of the moveable portion and the moveable portion is attached to the handle such that the plane of the working section is rotated on the longitudinal axes so that the plane of the working section is non co-planar with the substantially planar surface of the shaft of the handle.

22. A hand controlled apparatus as claimed in claim 21 wherein the plane of the working section is on a plane parallel to the plane created by the first and second axis.

23. A hand controlled apparatus as claimed in any one of claims 19 to 22 wherein the working section which is operational to a user over a majority of a 360 degrees rotation of the handle.
